(19) United States
(12) Patent Application Publication
(10) Pub. No.: US 2012/0070524 A1
(43) Pub. Date: Mar. 22, 2012

(54) MOLD FOR PROCESSING OPTICAL FILM AND MANUFACTURING METHOD THEREOF

(75) Inventor: CHIA-LING HSU, Tu-Cheng (TW)

(73) Assignee: HON HAI PRECISION INDUSTRY CO., LTD., Tu-Cheng (TW)

(21) Appl. No.: 12/952,159

(22) Filed: Nov. 22, 2010

(30) Foreign Application Priority Data
Sep. 21, 2010 (TW) 99131903

(51) Int. Cl. B29C 59/04; B29D 11/00

(52) U.S. Cl. 425/115; 264/2.5

(57) ABSTRACT

A mold for processing an optical film includes a substrate defining a microstructure on an outer surface thereof for printing a pattern on the optical film, an aluminum oxide film, and a hydrophobic fluorinated self-assembled monolayer film. The aluminum oxide film is formed on an outer surface of the substrate by atomic layer deposition. The hydrophobic fluorinated self-assembled monolayer film is formed on an outer surface of the aluminum oxide film. The mold provides easy release of the hydrophobic fluorinated self-assembled monolayer film and protection for the mold from abrasion.

### BACKGROUND

1. Technical Field

The disclosure relates to molds, and particularly to a mold for processing optical film.

2. Description of the Related Art

While LCD (liquid crystal display) is important and popular as a display technology, because the liquid crystal does not illuminate itself, backlight modules are commonly required.

An optical film is a component of the backlight module. One of key technologies of the backlight module is manufacture of the optical film. The main function of the optical film is utilization of the microstructure of the optical film to change the path of light and increase brightness, range, and the uniformity of illumination.

In common use, a UV glue is coated on the substrate, and then embossed, utilizing a roller having a microstructure to impress and transform the microstructure on the substrate. Finally, the microstructure of the optical film is cured with the UV light. Frequently, mold release is an important and difficult stage of the process, and accompanying remnants of UV glue can generate defects in the optical film and affect the shape of subsequently molded optical film. In addition, undesired particulate matter generated during manufacture can abrade the microstructure of the roller, reducing lifetime thereof.

Thus, it is desirable to provide a mold for processing optical film which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present mold for processing optical film. Moreover, in the drawings, like reference numerals designate corresponding parts throughout the views.

FIG. 1 is a flowchart of a manufacturing method for a mold in accordance with a first embodiment.

FIG. 2 is a schematic view of a mold in accordance with a first embodiment.

### DETAILED DESCRIPTION

Embodiments of a mold for processing optical film as disclosed are described in detail here with reference to the drawings.

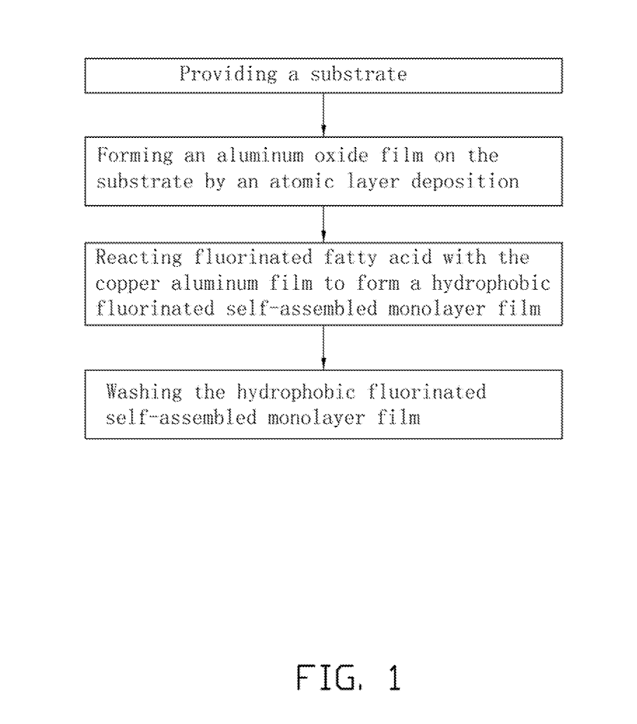

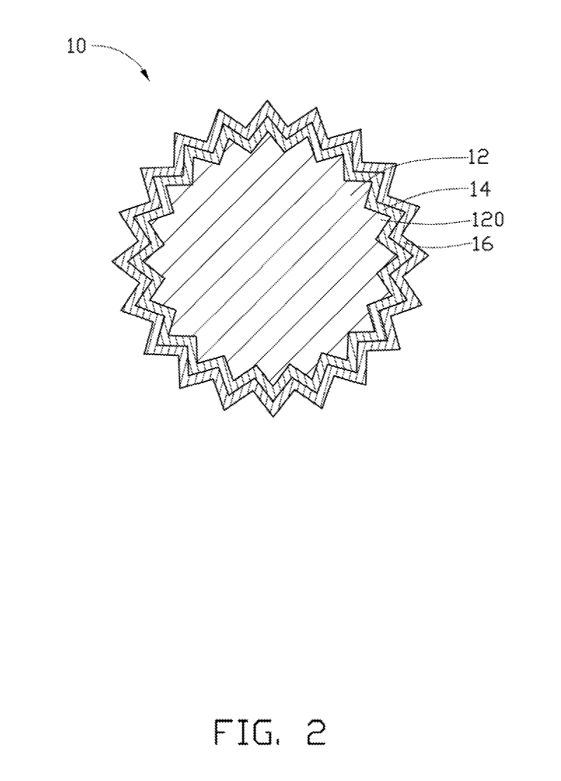

Referring to FIGS. 1 and 2, a method for manufacturing a mold 10 for processing optical film includes providing a substrate 12, forming a hard aluminum oxide film 14 on a surface of the substrate 12 by atomic layer deposition (ALD), reacting fluorinated fatty acid with the aluminum oxide film 14 to form a hydrophobic fluorinated self-assembled monolayer film 16, and washing the hydrophobic fluorinated self-assembled monolayer film 16.

The substrate 12 can be a copper roller, or another material or shape.

The substrate 12 defines a microstructure 120 on its surface to print a pattern on optical films or other subject.

In the second step, the substrate 12 undergoes an ALD process in a vacuum chamber. Gas in the chamber is exhausted until the inner pressure reaches about 0.1Torr, and is heated until the inner temperature reaches a predetermined temperature between 100° C. and 400° C. For example, the inner temperature may be stably controlled at about 250° C. in this embodiment. Next, trimethyl aluminum (TMA, (CH₃)₃Al) and oxygen are introduced in the chamber by turns as a precursor and an oxidant. The TMA and oxygen react to form aluminum oxide deposited on the substrate 12. The deposited aluminum oxide film 14 may have a thickness between 50 nm and 150 nm.

The precursor may be other aluminum-containing compounds, such as AlCl₃, (C₂H₅)₃Al or (C₃H₇)₃Al. The oxidant may be O₃, H₂O or other.

Reaction of fluorinated fatty acid with the aluminum oxide film 14 can further comprise placement of substrate 12 having the aluminum oxide film 14 into a hermetically sealed chamber with an inert gas, such as nitrogen, and addition of perfluorinated fatty acid with a long linear carbon chain into the chamber at a concentration of 0.2% of volume of the chamber. In this embodiment, the perfluorinated fatty acid with a long linear carbon chain is CF₃(CF₂)ₙCOOH, wherein n is 3, 6, 8, 10, or 16.

The chamber is heated to 200° C. and maintained for three hours to vaporize the perfluorinated fatty acid, hermetically covering the substrate 12. Chemical adsorption occurs between a carboxyl group of the vaporized perfluorinated fatty acid and the aluminum oxide film 14 of the substrate 12 and dehydration reaction occurs between the carboxyl group of the vaporized perfluorinated fatty acid and the aluminum oxide film 14 of the substrate 12. Thus, the fluorinated self-assembled monolayer film 16 is formed on the substrate 12. Because the perfluorinated fatty acid has C—F bonding, the fluorinated self-assembled monolayer film 16 is hydrophobic. The temperature of dehydration can be any temperature higher than the vaporizing temperature of the perfluorinated fatty acid.

The perfluorinated fatty acid with long linear carbon chain can be replaced with partial fluorinated fatty acid with long linear carbon chain, such as CF₃(CF₂)ₙ(CH₂)ₙCOOH, wherein n+m is 3, 6, 8, 10, or 16, and n and m are both integers.

Reaction of fluorinated fatty acid with the aluminum oxide film 14 can be accomplished by introducing the inert gas into the chamber of the second step, controlling the temperature to 200° C., and introducing the perfluorinated fatty acid into the chamber.

The substrate 12 is slowly cooled.

Chloroform, acetone, alcohol, and deionized water are sequentially employed to wash an outer surface of the fluorinated self-assembled monolayer film 16 of the mold 10 and remove remaining fluorinated fatty acid.

Referring particularly to FIG. 2, the mold 10 for processing optical film in accordance with the first embodiment includes the substrate 12, the aluminum oxide film 14 formed on the substrate 12, and the fluorinated self-assembled monolayer film 16 formed on the aluminum oxide film 14.

The substrate 12 is a copper roller in this embodiment, and the substrate 12 can be other shape. The surface of the substrate 12 forms the microstructure 120 utilized to create a pattern on an optical film. In this embodiment, the microstructure 120 is with V-shape recessions extending along an axis of the substrate 12.

The aluminum oxide film 14 is formed by an ALD with a thickness between 50 nm and 150 nm. The fluorinated self-assembled monolayer film 16 is formed by dehydration reaction of the aluminum oxide film 14 and perfluorinated fatty acid (CF3(CF2)nCOOH), wherein n is 3, 6, 8, 10, or 16, or partial fluorinated fatty acid (CF3(CF2)n(CH2)mCOOH), wherein n+m is 3, 6, 8, 10, or 16, and n and m are both integers. The fluorinated self-assembled monolayer film 16 is highly hydrophobic.

The disclosure provides the mold 10 for processing optical film having a highly hydrophobic fluorinated self-assembled monolayer film 16 which is easily released from the mold 10. Furthermore, the aluminum oxide film 14 formed by the ALD provides superior hardness, and functions as a protective layer to protect the mold 10 from abrasion, such that lifetime of the mold 10 is increased.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for manufacturing a mold for processing an optical film, comprising:
providing a substrate defining a microstructure on an outer surface thereof for printing a pattern on the optical film;
performing an atomic layer deposition process to form an aluminum oxide film on the outer surface of the substrate; and
dehydrating the aluminum oxide film with a fluorinated fatty acid to form a fluorinated self-assembled monolayer film on an outer surface of the aluminum oxide film.

2. The method of claim 1, wherein the step of performing the atomic layer deposition process comprising:
placing the substrate in a chamber at a pressure of 0.1 Torr and a temperature between 100° C. and 400° C.; and
introducing a precursor and an oxidant into the chamber.

3. The method of claim 2, wherein the precursor is trimethyl aluminum (TMA, (CH₃)₃Al) and the oxidant is oxygen.

4. The method of claim 2, wherein the precursor comprises AlCl₃, (C₂H₅)₃Al or (C₃H₇)₃Al.

5. The method of claim 2, wherein the oxidant comprises O₃ or H₂O.

6. The method of claim 1, wherein the step of dehydrating the aluminum oxide film comprising:
placing the substrate having the aluminum oxide film in a chamber filled with an inert gas;
introducing the fluorinated fatty acid into the chamber; and
heating the chamber to vaporize the perfluorinated fatty acid.

7. The method of claim 6, wherein the temperature of dehydrating the aluminum oxide film is higher than a vaporizing temperature of the perfluorinated fatty acid

8. The method of claim 7, wherein the temperature of dehydrating the aluminum oxide film is 200° C.

9. The method of claim 6, wherein a concentration of the perfluorinated fatty acid is 0.2% of volume of the chamber.

10. The method of claim 6, wherein the fluorinated fatty acid is a perfluorinated fatty acid with long linear carbon chain (CF₃(CF₂)nCOOH), wherein n is 3, 6, 8, 10, or 16.

11. The method of claim 6, wherein the fluorinated fatty acid is a partial perfluorinated fatty acid with long linear carbon chain (CF₃(CF₂)ₙ(CH₂)ₘCOOH), wherein each of n+m is 3, 6, 8, 10, or 16, and n and m are both integers.

12. The method of claim 6, further comprising washing an outer surface of the fluorinated self-assembled monolayer film with chloroform, acetone, alcohol, and deionized water sequentially.

13. The method of claim 1, wherein the aluminum oxide film has a thickness between 50 nm and 150 nm

14. A mold for processing an optical film comprising:
a substrate defining a microstructure on an outer surface thereof for printing a pattern on the optical film, an aluminum oxide film formed on an outer surface of the substrate, and a fluorinated self-assembled monolayer film formed on an outer surface of the aluminum oxide film, wherein the fluorinated self-assembled monolayer film is formed by dehydration with the aluminum oxide film and the fluorinated fatty acid.

15. The mold for processing an optical film of claim 14, wherein the fluorinated self-assembled monolayer film is a perfluorinated self-assembled monolayer film or a partial fluorinated self-assembled monolayer film.

16. The mold for processing an optical film of claim 14, wherein substrate is in a form of a roller.

17. The mold for processing an optical film of claim 16, wherein the microstructure comprises a plurality of V-shaped recessions extending along an axis of the substrate.
